(19) United States
(12) Patent Application Publication
(10) Pub. No.: US 2007/0117070 A1
(43) Pub. Date: May 24, 2007

(54) Vocational assessment testing device and method

(76) Inventor: Alvin Krass, Little Silver, NJ (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/284,916

(22) Filed: Nov. 23, 2005

(51) Int. Cl. G09B 19/00

(52) U.S. Cl. 434/219

(57) ABSTRACT

The invention concerns a vocational aptitude testing method and device for detecting the aptitudes and interests of subjects having various cognitive abilities to a range of activities, that makes it possible to select at least one task among a library of tasks, provide instructions regarding the at least one task to the subject, provide at least one stimulus of the at least one task to the subject, detect at least one action by the subject in response to the at least one stimulus, and perform at least one of collecting, processing, presenting, transmitting, and displaying data obtained from the test subject's response.

### FIELD OF THE INVENTION

The invention relates generally to the field of vocational ability assessment, and more particularly, to the measurement and assessment of the performance of tasks related to various selected occupations, for example in the context of identifying training options or placement in various occupations.

### DESCRIPTION OF RELATED ART

For years, professionals have studied the effects that verbal ability, motor skills, and temperament have on a person's abilities. Tests have been developed for measuring, e.g., simple and complex attention reaction, working memory, short-term memory, and new learning, incidental memory, adaptive problem solving, continuous performance and spatial ability. These have generally also been used to identify potential for disability or actual disability, but not to identify occupational potential.

Many cognitive test instruments are designed for single assessment situations or to answer specific diagnostic questions or to measure a specific cognitive skill, and often make use of the novelty of the test. These are rarely adapted to performing more than a few assessments in an individual, because the subject may benefit from second and subsequent repetitions of the test, making normative data (based on the single test administration) inappropriate.

In addition, many test instruments are specifically designed for subjects functioning at a specific level and do not work well with persons who are not functioning at that level. For example, typically, a test that is useful for a “high” functioning group of subjects, such as jet pilots, may be considerably less useful for a “low” functioning group, such as special needs or disabled persons.

Accordingly, there is a need for a universal vocational aptitude testing device and method that are adapted to accommodate a wide spectrum of cognitive functional levels. There is also a need for a device and method that can reliably and adaptively detect deviations in a person's cognitive levels, to help identify the aptitude and vocational choice for that person. There is further a need for a device and method that can reliably detect the deviation in a person's cognitive level over time in connection with the person's ability to perform tasks for various occupations. In particular, there is a need for a method and device for identifying occupational potential, such as by measuring functions to assess a subject's potential for job training or placement, in particular with a computerized test.

### SUMMARY OF THE INVENTION

The invention is provided in order to remedy some or all of the drawbacks of the existing art.

Thus, in an aspect of the invention, an objective of the invention is to provide a vocational aptitude testing device and method using a library of tasks for indexing those performance levels which relate to prospective job performance.

In another aspect of the invention, an objective of the invention is to provide a vocational aptitude testing device and method that may be used for subjects with various cognitive abilities, from high function subjects to persons with disabilities.

In still another aspect of the invention, an objective of the invention is to provide a computer implemented vocational aptitude testing device and method that allows the examiner to modify testing parameters without modifying the program code, and in particular, to provide computer implemented vocational aptitude tests having variable task parameters, derived from a task analysis of a specified occupation.

Accordingly, in one aspect, the present invention provides a vocational aptitude testing method for detecting the aptitude of subjects having various cognitive abilities to a range of activities, comprising:
selecting at least one task among a library of vocational aptitude tasks;
providing instructions regarding the at least one task to the subject;
providing at least one stimulus of the at least one task to the subject;
detecting at least one action by the subject in response to the at least one stimulus;
performing at least one of collecting, processing, presenting, transmitting, and displaying data obtained from the test subject's response.

In another aspect, the invention provides a vocational aptitude testing device for detecting the aptitude of subjects having various cognitive abilities to a range of activities, comprising:
a library of vocational aptitude tasks;
a menu module for allowing the subject or a test administrator to select at least one task in the library;
an instruction module for providing instructions regarding the at least one task to the subject;
a performance module for providing at least one stimulus of the at least one task to the subject and detecting at least one action by the subject in response to the at least one stimulus;
an analysis module for performing at least one of collecting, processing, presenting, transmitting, and displaying data obtained from the test subject's response.

In particular embodiments, the menu module allows the subject or a test administrator to customize parameters of the tasks in the library, to modify a task by combining portions of several tasks and/or to add new tasks to the library.

The instruction module provides advantageously at least one of textual, visual, and audio stimuli.

The performance module can comprise at least one input device input device such as a mouse, a keyboard, a touch screen, a dedicated response button, for example, the performance module may comprise at least two input devices. In addition it may have a routine or other means may be provided for measuring responses, for example, through the computer program itself.

In some embodiments, the analysis module comprises a statistical analysis module for generating statistical information on the subject's response. A further correction module that interrupts performance of a task if the subject's actions are repeatedly erroneous, and/or a subject information demographic module for gathering subject information, may be provided.

In some variants, the library includes tasks adapted to assess subjects with various cognitive abilities, tasks adapted to assess performance levels of subjects in relation to a prospective professional occupation, and/or at least one task adapted to determine the subject's ability to perform an activity and at least one task adapted to determine the subject's interest in performing the activity.

In preferred embodiments, at least one of the modules is implemented by computer program instructions, for example, all modules are implemented by computer program instructions. The computer program may be stored in a computer or in a computer usable storage medium, for example. In some embodiments, the program code executes entirely on a computer, and in other embodiments, the program code partly on a local computer and partly on a remote computer, or completely on a remote computer. Instructions or response data may be sent via a network of computers in some cases.

### BRIEF DESCRIPTION OF THE FIGURES

FIG. 1 is a block diagram of vocational aptitude assessment device according to the present invention;

FIG. 2 is a block diagram of a remotely implemented device according to the invention;

FIG. 3 is a block diagram of a stand-alone device according to the invention;

### DETAILED DESCRIPTION OF PARTICULAR EMBODIMENTS

Examples of the present invention are described further hereinafter with reference to the accompanying drawings in which particular embodiments of the invention are shown.

The present invention may include a series of components including a library of vocational aptitude tasks, a menu program, and an analysis program. The components may function individually or in concert with one another.

The library of tasks comprises a plurality of tasks that may be designed to index or assess potential vocational skills. These tasks may be computer-implemented, and they may have been modified for computer implementation or have been developed for computer implementation. Many of the tasks include a response that facilitates alteration of certain parameters of the task by the test administrator without modifying the underlying program code, thus making the tasks useful for indexing multiple skills.

A menu program allows the test administrator to select one or more tasks to be performed from the library and to customize parameters of those tasks altering the responses. The test procedures can be modified by a user directly, for example, from a touch screen, or by changing cards, or through an external computer network of computers. The tests can be adapted to particular objectives or uses. For example, individual features of each test, such as the type of visual or audio signals and the type of subject's action which is detected can be modified. Also, individual features of the above tests can be combined to form new tests. The test procedures described above are given only as examples, and other test procedures may be used in addition or in place of these examples.

In addition, each task is implemented through an instruction module and a performance module. The instruction module provides instructions to the test subject for implementing the task. The test subject interacts with the performance module to carry out the task.

The instruction module preferably includes program code for generating textual instructions on a computer screen for implementing performance module. Such instructions may include informing the test subject as to the type of input device, e.g., mouse, keyboard, button, touch-screen, etc., to be used to respond to stimuli and queries generated by the performance module. The instruction module may further include image and queries generated by the performance module. The instruction module may also include image, video and/or audio files, to augment or replace the textual instructions for assisting test subjects who have trouble reading the textual instructions. In this manner, the tests can be adapted to be administered to, e.g., subjects who are illiterate, intellectually challenged, or non-English speakers.

In a variant of the invention, various agent character or characters may be used. Agent characters may be programmed to move and speak, enhancing the quality and understanding of the test instructions and providing an avenue of appeal for subjects that are unique, e.g., children, the elderly, etc. The test administrator may alter the movements and speech of the agent characters.

The performance module generates stimuli on the computer screen to which the test subject is prompted to respond. Such stimuli may be visual, aural, or audio-visual. In a variant of the invention, aural stimuli are provided, e.g., in order to facilitate testing of subjects who are visually impaired, or where the test administrator desires to mimic an environment in which the test subject cannot see a computer monitor. In alternative embodiments of the invention, additional components may be included, which may be mounted on the apparatus or connected to the apparatus through a wire or wireless connection, or other communication device.

For each test, the test subject may respond to stimuli using an input device such as a mouse, a keyboard, a touch screen, a dedicated response button, or another input device, such as those described in U.S. Pat. No. 6,517,480, which is hereby incorporated by reference in its entirety.

An analysis module may be provided to exploit the subject's actions in response to the stimuli. The analysis module may perform one or more of the following steps: collecting, interpreting, presenting, displaying data, such that the data may be readily interpreted by a professional (typically a vocational counselor), for example, through a graphics program. The data is preferably organized so as to represent a test subject's abilities and/or interests in a specific occupation or list of occupations.

In accordance with an aspect of the invention, data generated by the tests may be processed by a statistical analysis module to generate statistical information, e.g., mean/median, reaction time, accuracy, thoroughness, etc. In particular, the statistical analysis program collects, interprets, and analyzes data generated by performance of the tasks. In this manner, the interaction of task performance in various tests can be used to identify the work activities best fitted to the test subject.

In a further embodiment of the invention, a correction module is provided with the performance module. For example, the correction module monitors the first N responses to the first N stimuli generated by the performance module, where N is an integer selected by the test administrator. If the first N responses are incorrect, the correction module interrupts the task and provides an indication that there may be a misunderstanding of the instruction, for example, by displaying a message on a computer screen. At that point, the instruction module may be designed to display the instruction again and the performance module may be adapted to restart the task. After a predetermined number of successive task interruptions, the performance module stops the test, and, for example, displays a message on the computer screen directing the test subject to contact the test administrator. In this manner, the correction module helps prevent accumulation of bad test data due to lack of understanding of the test instructions. In this manner, the subject's misunderstanding of task instructions may be detected, and a useable profile to help identify best fit for vocational placement or training, may be obtained.

According to a variant of the invention, a data collection module, for example, a subject information demographic module, may be provided with the library for collecting data relating to the test subject and creating a corresponding database. Preferably, this module provides a simple mechanism, e.g., GUI, for recording important participant demographic and medical information in a format compatible with database standards and with data produced by the test modules.

A GUI may include one or several of the following data fields, for example: subject ID, battery identification, age, sex, race, occupation, hand preference, years of education, diagnostic code 1, diagnostic code 2, medications, and comments, as well as other possible data fields. The GUI and corresponding database may also be customized for specific test subjects to include one or several data fields, for example, up to three data fields that are specific to the research or clinical purpose for administering the test.

Vocational aptitude tasks may include conventional testing procedures that are adapted to determine a subject's ability to perform specific occupations and to determine a subject's interest in performing specific occupations. The tests may have been developed following or based on established standards for a specific occupation, such as various professional standards which are well known in the art, or they may have been developed for the purpose of evaluating a specific occupation, under DOT or SOC classifications or others. For example, a group of tasks within the library may include or correspond to standards described in the US Dictionary of Occupational Standards, and/or other directories developed elsewhere. The tasks may be adapted to determine a skill profile of the subject. A battery of tasks may have been organized in accordance with a job training program.

Examples of tasks that may be included in the library are set forth in Table 1 below. The library may include any number or grouping of the tasks below, for example at least 3, at least 5, at least 10, and optionally additional tasks other than those listed in Table 1.

TABLE 1
Exemplary task library

| | | Employment/vocational |
|---|---|---|
| Task | What the task measures | correlation |
| Arithmetic | Ability to perform math | Ability to perform basic |
| | problems, ranging from simple | computational problems |
| | addition to calculus | accurately |
| Auditory acuity | Ability to hear and respond to | Ability to perceive and |
| | sound | respond to signals and danger |
| | | cues, to follow verbal |
| | | directions, and to interact |
| | | socially |
| Auditory localization | Ability to identify accurately | Ability to respond effectively |
| | the direction from which | to sound in the work |
| | sound signals start | environment |
| Auditory memory | Ability to remember what one | Ability to retain information |
| | hears | gathered by hearing and to |
| | | follow directions |
| Color vision | Ability to see color accurately | Ability to perceive and |
| | | discriminate color coded |
| | | information |
| Eye-hand coordination time | Amount of time to perform | Ability to perform tasks that |
| | tasks requiring motor control | require eye-hand coordination |
| | of left and right hands | with speed |
| Eye-hand coordination | Accuracy of performance of | Ability to perform tasks that |
| accuracy | tasks requiring motor control | require eye-hand coordination |
| | of left and/or right hands | with accuracy |
| Independent living skills | Maturity and social | Ability to function in socially |
| | responsibility | responsible manner |
| Language series | Vocabulary skills, reading | Ability to understand the |
| | comprehension, and language | meaning of words and of |
| | usage skills | language and context |
| Persistence | Performance motivation | Ability to perform repetitive |
| | derived from the repetition of | tasks without performance |
| | a task (subtest) | decline or variability |
| Physical condition | Level of physical well-being | Ability to perform jobs that |
| | derived from results of | are physically demanding |
| | structured interview | |
| Problem solving-time | Time taken to observe and | Ability to perform visual |
| | learn from a demonstrated task | hands-on tasks efficiently |
| Problem solving-accuracy | Ability to observe and learn | Ability to perform visual |
| | from a demonstrated task | hands-on tasks accurately and |
| | | with precision |
| Problem solving-style | Whether a new task is learned, | Ability to learn from |
| | how quickly, and whether the | observation and to generalize |
| | learning is retained | and apply methods |
| | | independently |
| Problem solving-effectiveness | Effectiveness, or slope, of | Ability to learn a new task and |
| | learning a hands-on task | repeat it while improving |
| | | hands-on performance over |
| | | time |
| Reaction time to light | Speed with which one | Ability to respond effectively |
| | responds to a visual signal | to visual signals |
| Reaction time to sound | Speed with which one | Ability to respond effectively |
| | responds to a sound signal | to sound signals |
| Reaction time to combined | Speed with which one | Ability to respond effectively |
| light and sound | responds to simultaneous light | to visual and auditory signals |
| | and sound signals | |
| Spatial reasoning | Time and accuracy in | Ability to solve problems and |
| | completing tasks requiring | reason without concrete cues, |
| | reasoning in an abstract and | to reason from a specific cue, |
| | spatially-related way | to troubleshoot |
| Visual acuity | Ability to see accurately | Ability to perceive visual |
| | | stimuli and to perform tasks |
| | | requiring good vision |
| Visual memory | Whether an demonstrated task | Ability to retain information |
| | is observed and repeated in an | gathered through signs |
| | accurate and timely manner | |

A vocational interest test may be incorporated into the test administration. For example, the subject may be asked to respond to a graphic portrayal of various occupations, by rating a degree of interest, or via another form of presentation following methods which are know in the art or will be otherwise available to the person of the art. An interest profile is thus incorporated into the methodology for selecting recommended occupational choices.

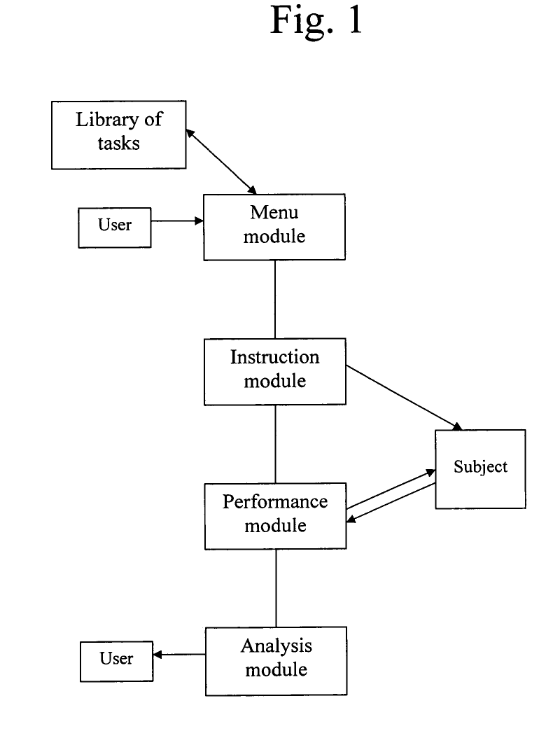

As shown by the block diagram of FIG. 1, each block of the diagram, and each group or combination of blocks can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the flow chart block or blocks.

These computer program instructions may also be stored in a computer readable memory that can direct a computer or other programmable data processing apparatus to function in a particular manner, such that the instructions stored in the computer-readable memory produce an article of manufacture including instruction means or program code that implements the function specified in the flow chart block or blocks.

As will be appreciated by one of skill in the art, the present invention may be embodied as a computer implemented method, a programmed computer, a data processing system, a signal, and/or computer program. Accordingly, the present invention may take the form of an entirely hardware embodiment, an entirely software embodiment, or an embodiment combining software and hardware aspects. Furthermore, the present invention may take the form of a computer program on a computer usable storage medium having computer usable program code embodied in the medium. Any suitable computer readable medium may be utilized including hard disks, CD-ROMS, DVD-ROMS, optical storage devices, or other storage devices.

Computer program code for carrying out operations of the present invention may be written in a plurality of languages, and it may be internet-enabled.

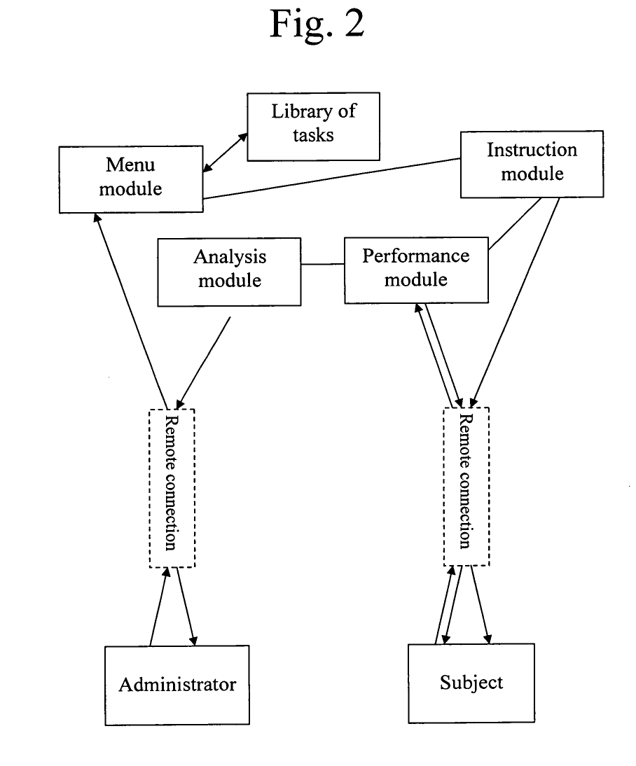

As shown on FIG. 2, the program code may execute entirely on the user's or test subject's computer, as a stand-alone software package, or it may execute partly on the user's computer and partly on a remote computer, or completely on a remote computer. In the latter scenario, the remote computer may be connected directly or the user's computer via a LAN or a WAN (Intranet), or the connection may be made indirectly through an external computer (For example, through the internet). Thus, the program may be administered entirely remotely through a computer network, including selection of tests before or during the testing, online payment and authorization of initial and/or additional tests, viewing of test results for each subject as well as for groups of individuals by geography and/or by aptitude, for example. The testing process may be self-paced or directed by automatic instruction or administrator direction.

In particular, the computer program instructions may also be loaded, e.g., transmitted via a carrier wave, to a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flow chart block or blocks.

Various template, program code, and the database(s) according to the present invention may be stored locally on a provider's stand-alone computer terminal, such as a desktop computer, laptop computer, palmtop computer, or personal digital assistant (PDA) or the like.

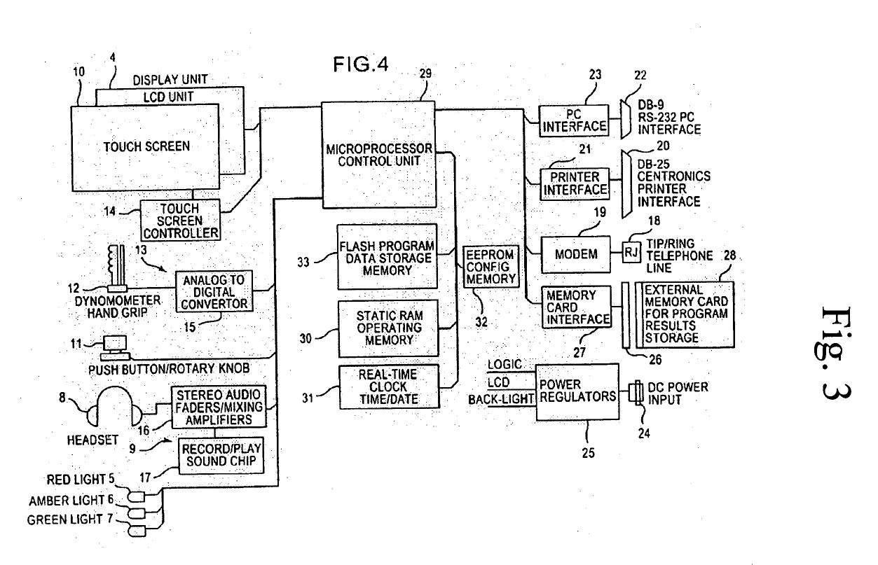

As illustrated in FIG. 3, a dedicated or non-specific device for implementing the present invention may be constructed using as starting point a device as disclosed in U.S. Pat. No. 6,517,480 to Krass, which is hereby incorporated herein in its entirety. Of course, a standard PC may be used or adapted as a device according to the present invention, or for performing the method of the present invention.

Although the invention has been described with reference to specific embodiments, the invention is not limited to such embodiments, but various modifications and alternative embodiments will be apparent to persons skilled in the art in view of the general disclosure of the invention and particular embodiment described herein.

1. A vocational aptitude testing device for detecting the aptitude of subjects having various cognitive abilities to a range of activities, comprising:
a library of vocational aptitude tasks;
a menu module for allowing the subject or a test administrator to select at least one task in the library;
an instruction module for providing instructions regarding the at least one task to the subject;
a performance module for providing at least one stimulus of the at least one task to the subject and detecting at least one action by the subject in response to the at least one stimulus;
an analysis module for performing at least one of collecting, processing, presenting, transmitting, and displaying data obtained from the test subject's response.

2. The device of claim 1, wherein the menu module allows the subject or a test administrator to customize parameters of the tasks in the library.

3. The device of claim 2, wherein the menu module allows the subject or a test administrator to modify a task by combining portions of several tasks.

4. The device of claim 1, wherein the menu module allows the subject or a test administrator to add new tasks to the library.

5. The device of claim 1, wherein the instruction module provides at least one of textual, visual, and audio stimuli.

6. The device of claim 1, wherein the performance module comprises at least one input device input device such as a mouse, a keyboard, a touch screen, a dedicated response button.

7. The device of claim 6, wherein the performance module comprises at least two input devices.

8. The device of claim 1, wherein the analysis module comprises a statistical analysis module for generating statistical information on the subject's response.

9. The device of claim 1, further comprising a correction module that interrupts performance of a task if the subject's actions are repeatedly erroneous.

10. The device of claim 1, further comprising a subject information demographic module for gathering subject information.

11. The device of claim 1, wherein the library includes tasks adapted to assess subjects with various cognitive abilities.

12. The device of claim 1, wherein the library includes tasks adapted to assess performance levels of subjects in relation to a prospective professional occupation.

13. The device of claim 1, wherein the library includes at least one task adapted to determine the subject's ability to perform an activity and at least one task adapted to determine the subject's interest in performing the activity

14. The device of claim 1, wherein at least one of the modules is implemented by computer program instructions.

15. The device of claim 14, wherein all modules are implemented by computer program instructions.

16. The device of claim 15, wherein the computer program is stored in a computer.

17. The device of claim 15, wherein the computer program is stored in a computer usable storage medium.

18. The device of claim 15, wherein the program code executes entirely on a computer.

19. The device of claim 17, wherein the program code partly on a local computer and partly on a remote computer, or completely on a remote computer.

20. The device of claim 19, wherein instructions or response data are sent via a network of computers.

21. A vocational aptitude testing method for detecting the aptitude of subjects having various cognitive abilities to a range of activities, comprising:
selecting at least one task among a library of vocational aptitude tasks;
providing instructions regarding the at least one task to the subject;
providing at least one stimulus of the at least one task to the subject;
detecting at least one action by the subject in response to the at least one stimulus;
performing at least one of collecting, processing, presenting, transmitting, and displaying data obtained from the test subject's response.

22. The method of claim 20, wherein the library includes at least one task adapted to determine the subject's ability to perform an activity and at least one task adapted to determine the subject's interest in performing the activity.
